(19) United States
(12) Patent Application Publication
(10) Pub. No.: US 2011/0041069 A1
(43) Pub. Date: Feb. 17, 2011

(54) USER INTERFACE FOR AGGREGATING SERVICES IN A DATA PROCESSING SYSTEM

(75) Inventor: Mario Carletti, Usmate (IT)

Correspondence Address: GRAYBEAL JACKSON LLP, 400 - 108TH AVENUE NE, SUITE 700, BELLEVUE, WA, 98004, US

(73) Assignee: DOBYWEB S.R.L., Piacenza (PC) (IT)

(21) Appl. No.: 12/866,205

(22) PCT Filed: May 8, 2008
(86) PCT No.: PCT/EP2008/055700

§ 371 Date: Nov. 4, 2010

(30) Foreign Application Priority Data
Feb. 4, 2008 (IT) PC2008A000006

(51) Int. Cl. G06F 3/01

(52) U.S. Cl. 715/738

(57) ABSTRACT

An embodiment is proposed for assembling services available in a data processing system with distributed architecture; each service many require a set of (one or more) input parameters and/or provides a set of (one or more) output parameters. An embodiment of a corresponding method starts with the step of displaying a representation of each service in a graphical user interface. A plurality of representations of the services is selected in the graphical user interface. The selected representations of the selected services are then arranged into a graph in the graphical user interface; the graph includes a set of connectors, each one associating a set of (one or more) preceding selected representations of preceding selected services to a set of (one or more) following selected representations of following selected services. The method then continues by generating an aggregated service from the graph. The aggregated service includes an access point to the aggregated service. Starting code is provided for invoking each initial selected service (associated with no preceding selected service) in response to an invocation of the aggregated service through the access point. Synchronization code is instead used for setting the input parameters of each set of following selected services according to the output parameters of the associated preceding selected services, and for invoking each set of following selected services in response to an availability of the output parameters of the associated preceding selected services.

### PRIORITY CLAIM

The present application is a national phase application filed pursuant to 35 USC §371 of International. Patent Application Serial No. PCT/EP2008/055700, filed May 8, 2008; which further claims the benefit of Italian Patent Application PC2008A000006, filed Feb. 4, 2008; all of the foregoing applications are incorporated herein by reference in their entireties.

### TECHNICAL FIELD

An embodiment relates to the data processing field. More specifically, an embodiment relates to the aggregation of services in a data processing system.

### BACKGROUND

Modern data processing systems generally offer a number of services to their users; generally speaking, each service consists of a self-contained basic task, which may be invoked through a well-defined interface independently of its underlying implementation. A typical example is the Internet, wherein a huge amount of web sites provide services for substantially any kind of need (each one implemented by a corresponding web application).

However, each web site available in the Internet is a stand-alone component that only provides a specific functionality. Therefore, for each complex activity including a long series of operations, the users may have to find and access a large number of different web sites. For example, in order to organize a holiday, the user typically selects a destination (on a web site providing tourist information), books a flight (on a web site of an airline company serving the selected destination), rents a car (on a web site of a renting company available in the selected destination), books one or more accommodations along a desired travel itinerary (on web sites of booking facilities operating locally), and so on. As a result, the activity may become complex and time-consuming; the problem is further exacerbated by the proliferation of the web sites that makes it very difficult to see one's way among the myriad of offers available on the Internet.

Some solutions have been proposed in the last years in an attempt to cope with this difficulty.

For example, a web site may include hyper-links to other web sites providing functionalities that are likely to be requested in the same context; for example, the web site of an airline company may include hyper-links to a web site of a renting company and to a web site of a booking facility that have an agreement with it. However, the different web sites remain completely independent of each other.

Another solution is provided by a portal, which implements a single centralized access point to different web applications (through corresponding portlets, each one defining a fragment of code for building a whole web page of the portal). In this case as well, the web applications of the portal still remain completely independent of each other.

A more sophisticated technique is provided by the mash-up technology. In this way, it is possible to combine information coming from different web applications into a single mash-up application, which provides an integrated interface wherein any change in a specific web application is automatically reflected into all the other web applications. Nevertheless, the mash-up application only provides a macro-functionality that helps performing a portion of the whole activity, so that the above-mentioned problems are slightly alleviated but not completely solved (since very often the users still have to find and access additional web sites to complete the activity).

In any case, solutions known in the art are substantially static. Indeed, the web applications that may be invoked (through the corresponding hyper-links, in the portal, or in the mash-up application) are predefined by respective developers. At most, the users may only customize the look and feel of some web pages on an individual basis (so as to have directly available the web applications of common use).

However, no product exists for coordinating all the operations that are to be performed during a complex activity.

### SUMMARY

In its general terms, an embodiment is based on the idea of creating a workflow of execution of the services.

For example, an embodiment is a method for assembling services that are available in a data processing system with distributed architecture; each service requires a set of (one or more) input parameters and/or provides a set of (one or more) output parameters. The method starts with the step of displaying a representation of each service in a graphical user interface (for example, by means of a corresponding icon with sockets for the input parameters and plugs for the output parameters). A plurality of representations of the services is selected in the graphical user interface. The selected representations of the selected services are then arranged into a graph (in the graphical user interface); the graph includes a set of connectors, each one associating a set of (one or more) preceding selected representations of preceding selected services to a set of (one or more) following selected representations of following selected services. For example, the connector may be simple (from a single output parameter to a single input parameter) or complex (leading alternatively to different input parameters according to the corresponding output parameters). Moreover, some input sockets may be left free (so as to require an interaction with a user for entering the corresponding input parameters); for example, this operation may be performed by extracting the input parameters from accessible elements (such as output boxes) in pages of external services. The method then continues by generating an aggregated service from the graph. The aggregated service includes an access point to the aggregated service. Starting code is provided for invoking each initial selected service (associated with no preceding selected service) in response to an invocation of the aggregated service through the access point. Synchronization code is instead used for setting the input parameters of each set of following selected services according to the output parameters of the associated preceding selected services, and for invoking each set of following selected services in response to an availability of the output parameters of the associated preceding selected services.

Another embodiment is a computer program for performing the above-described method.

A further embodiment is a service for performing the same method.

A different embodiment is a corresponding system.

### BRIEF DESCRIPTION OF THE DRAWINGS

One or more embodiments, as well as further features and advantages thereof, will be best understood with reference to the following detailed description, given purely by way of a non-restrictive indication, to be read in conjunction with the accompanying drawings, in which:

FIG. 1 is a schematic block diagram of a data processing system that may be used to practice an embodiment,

FIG. 2 illustrates an exemplary application of an embodiment,

FIG. 3 is an example of icon representing a service according to an embodiment,

FIG. 4 is an example of graph representing an aggregated service according to an embodiment,

FIG. 5 shows an exemplary scenario of application of an embodiment,

FIG. 6 is a collaboration diagram representing the roles of the main software components that may be used to implement an embodiment, and

FIG. 7 is a class diagram modeling an example of service according to an embodiment.

### DETAILED DESCRIPTION

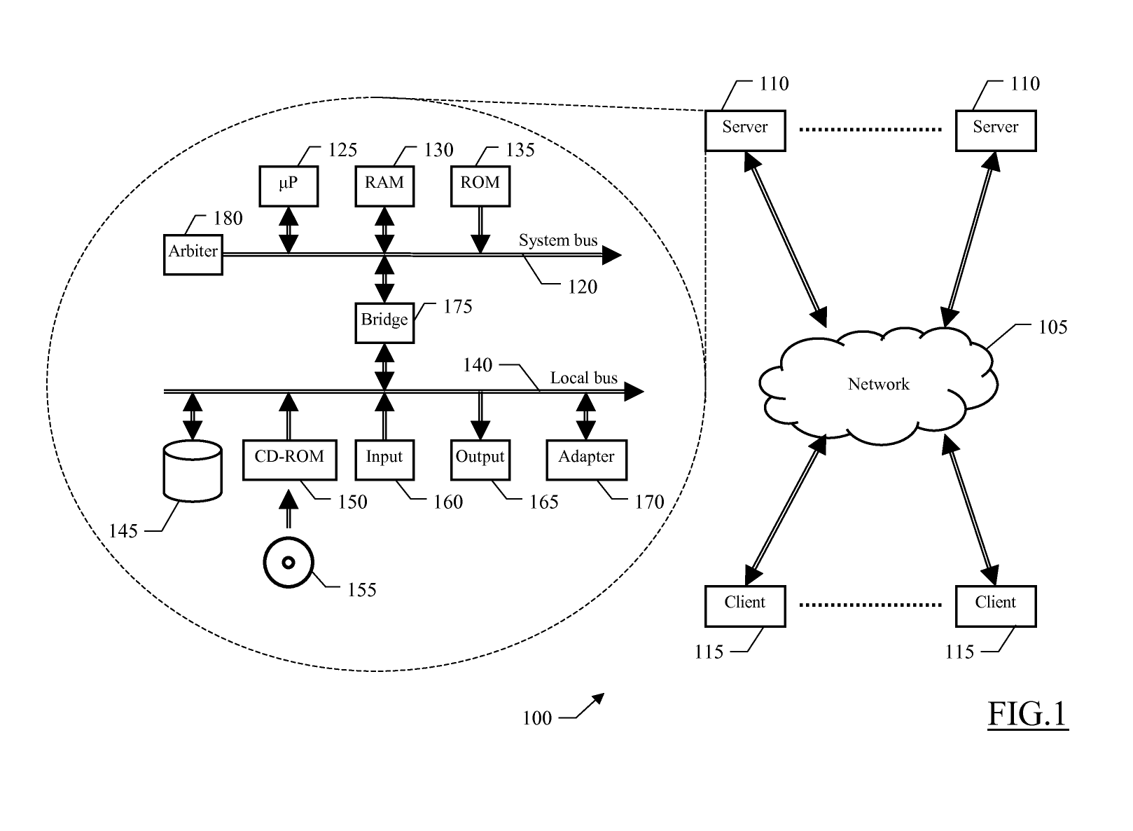

With reference in particular to FIG. 1, there is provided a schematic block diagram of an embodiment of a data processing system 100 that may be used to practice an embodiment. The system 100 has a distributed architecture, typically based on the Internet; the Internet is formed by millions of server computers (or simply servers), which are connected to each other through a global communication network 105. A subset of the servers (denoted with 110), known as World Wide Web or simply web, allows accessing corresponding web sites; each web site consists of a collection of web pages (connected to each other through corresponding hyper-links), which offer one or more services. Users of client computers (or simply clients) 115 access the Internet (through computers that operate as access providers, not shown in the figure), in order to exploit the services offered by the different servers 110.

A generic server 110 is formed by several units that are connected in parallel to a system bus 120. In detail, one or more microprocessors (μP) 125 control operation of the server 110; a RAM 130 is directly used as a working memory by the microprocessors 125, and a ROM 135 stores basic code for a bootstrap of the server 110. Several peripheral units are clustered around a local bus 140 (by means of respective interfaces). Particularly, a mass memory consists of one or more hard-disks 145, and drives 150 for reading DVD- or CD-ROMs 155. Moreover, the server 110 includes input units 160 (for example, a keyboard and a mouse), and output units 165 (for example, a monitor and a printer). An adapter 170 is used to connect the server 110 to the network 105. A bridge unit 175 interfaces the system bus 120 with the local bus 140. Each microprocessor 125 and the bridge unit 175 may operate as master agents requesting an access to the system bus 120 for transmitting information. An arbiter 180 manages the granting of the access with mutual exclusion to the system bus 120.

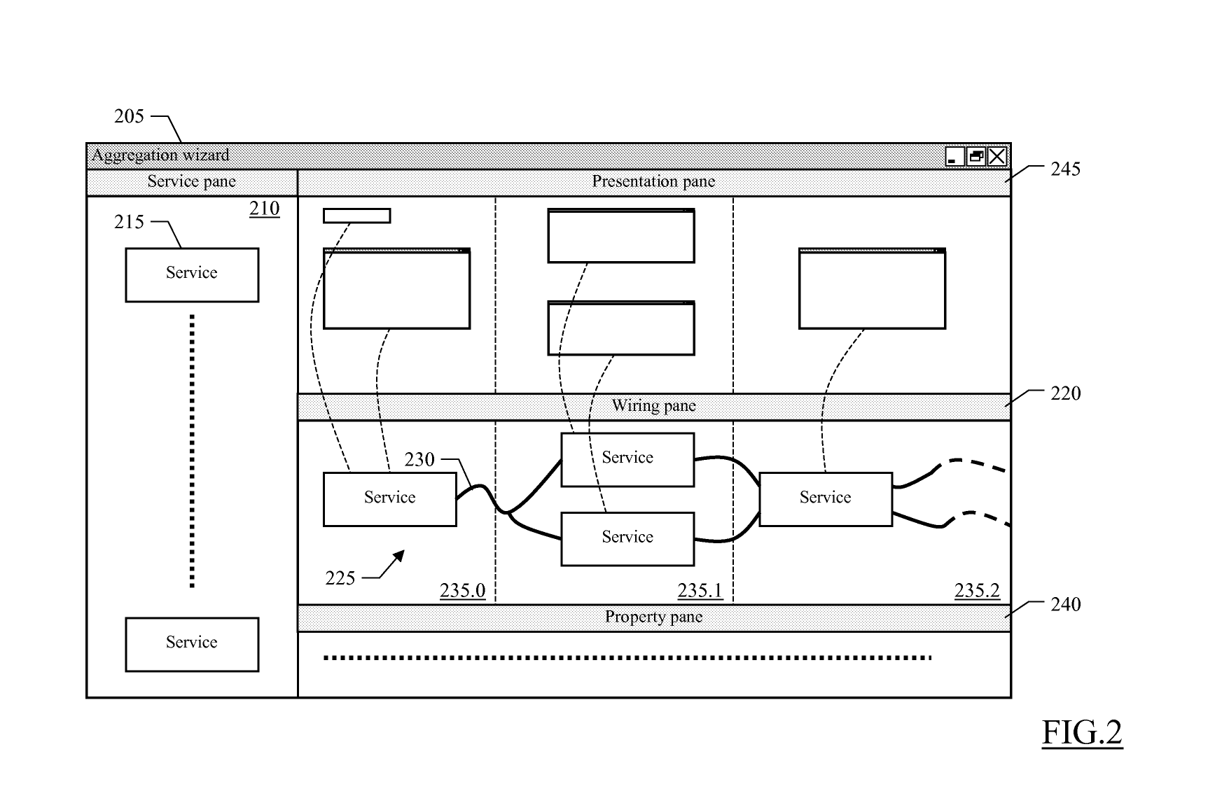

An exemplary application of an embodiment is illustrated in FIG. 2. Particularly, as described in detail in the following, an embodiment provides a Graphical User Interface (GUI) that implements a workbench for assembling the services that are available to the user of a generic client. For example, the GUI is implemented with an aggregation wizard running in a window 205.

The window 205 includes a service pane 210, which displays a graphical representation of each service—for example, in the form of a corresponding icon 215 (in the following, any objects and the corresponding representations will be denoted with the same references for the sake of simplicity). Each service 215 is a black box, which requires one or more input parameters and/or provides one or more output parameters (according to some sort of processing that may be completely transparent to the user). The service 215 may offer whatever functionality (for example, tourist information, flight booking, car renting, accommodation booking, and so on). The service 215 is either free of charge or subject to the payment of a subscription fee (even on a pay-per-use basis). The service pane 210 allows the user to search the services 215 according to different criteria (for example, their categories, authors, ratings, costs, and the like). The input/output parameters may be any kind of simple variables or complex variables (with a plurality of attributes). Examples of simple variables are strings (such as the name of a State), numbers (such as the length of a holiday), or dates (such as an arrival and a departure); examples of complex variables are cities (with their States and zip-codes), or hotels (with their categories and facilities).

The user may define a specific activity by selecting the icons 215 of the desired services—for example, by moving them with a drag-and-drop technique to a wiring pane 220. The icons 210 in the wiring pane 220 are arranged into a graph 225, wherein they are associated by means of corresponding connectors 230; particularly, each connector 230 associates one or more input parameters of one or more (following) services 215 with one or more output parameters of one or more (preceding) services 215 (with the addition of possible association functions). The graph 225 defines a succession of phases 235.i of the corresponding activity (with i=0 . . . N), which phases 235.i are separated by vertical dashed lines in the wiring pane 220. Each phase 235.i different from the first one (i.e., i>=0) includes a set of (one or more) following services 215 whose execution depends on the completion of a set of (one or more) associated preceding services 215 of the phase 235.i-1—with the (initial) services 215 of the first phase 235.0 that are associated with no preceding services.

The window 205 also includes a property pane 240 that is used to display and update any properties of a selected object. For example, when the user selects a service 215 (e.g., by double-clicking with the mouse over the corresponding icon), the property pane 240 provides a corresponding detailed description of its functionality, and a list of its input parameters and output parameters with their attributes; on the other hand, when the user selects a connector 230, the property pane 240 provides its input parameters of the preceding services 215 and the associated output parameters of the following services 215, together with a specification of any corresponding association function.

The graph 225 is used to generate an aggregated service automatically (for the corresponding activity). Particularly, the aggregated service has an access point for invoking it. Starting code is added for invoking each initial service 215 of the first phase 235.0 (in response to the invocation of the aggregated service through its access point). Synchronization code sets the input parameters of each following service 215 according to the associated output parameters of the preceding services 215; the synchronization code then invokes the following services 215 of each phase 235.i as soon as the output parameters of the associated preceding services 215 of the phase 235.i-1 are available.

A preview of the aggregated service so obtained is displayed into a presentation pane 245. Particularly, for each phase 235.i the presentation pane 245 provides any objects (such as input boxes or web pages) that are used to interact with the aggregated service.

An embodiment allows defining any desired workflow of execution of multiple services. In this way, a corresponding working model shifts from an unstructured paradigm (wherein an agglomerate of services each one consisting of a stand-alone component is available) to an automated paradigm (wherein the services may be federated into complex activities). All of the above may make it possible to capitalize best practices and/or individual knowledge.

As a result, the execution of whatever activity is strongly simplified, with a corresponding significant savings of time. Particularly, the aggregated services now guide the user through the different operations of complex activities (without the need of any investigation process to find the required services). Moreover, any information already entered into a preceding service is automatically passed to the following services, so that the users do not have to re-enter it (thereby strongly reducing the possibilities of errors).

The above-described embodiment is completely dynamic. Indeed, the services may be aggregated in a very simple way (even by users without specific technical skills). Therefore, it is possible to define any kind of aggregated services for whatever activities (according to contingent needs).

An embodiment is very useful for both personal applications and business applications. For example, an embodiment may be exploited to guide a user through the different operations that are required to book a holiday, to trade online, and so on. However, the same embodiment may also be used to publish a comprehensive management application with specific services for its different aspects (such as customer, supplier, marketing and order management). These services may then be aggregated at will by users of a community that cooperate to implement a complete management process.

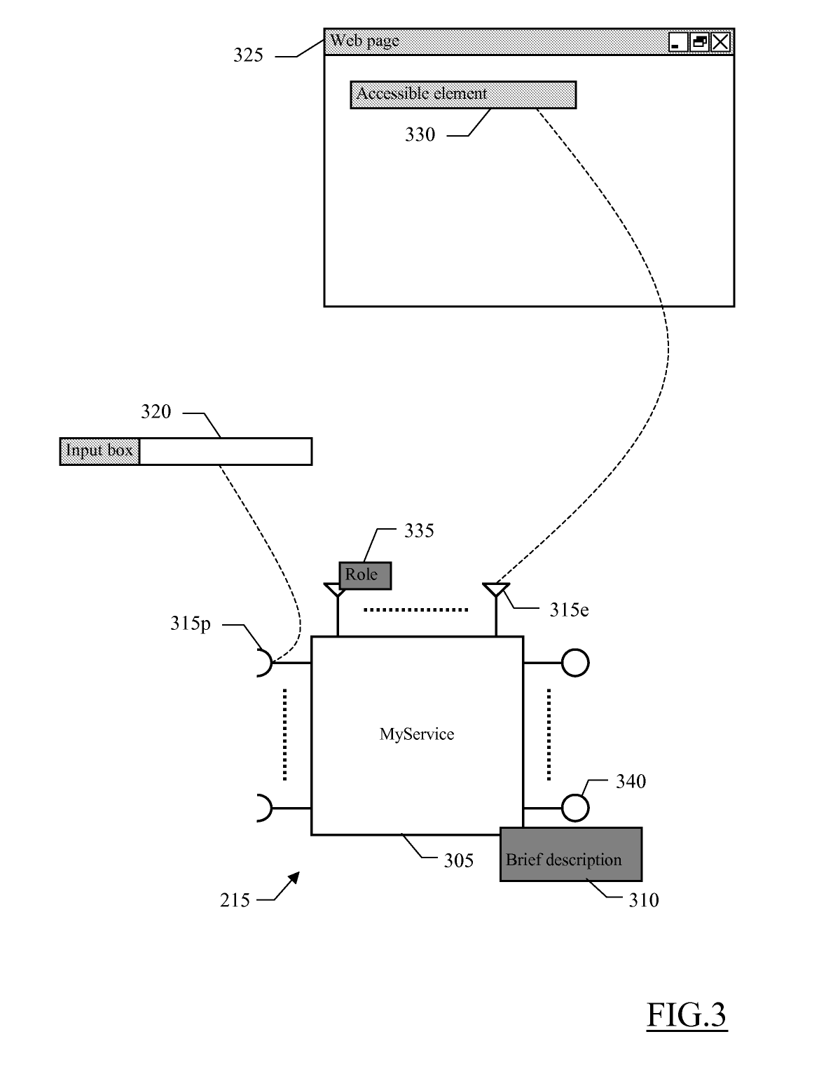

With reference now to FIG. 3, an example of icon 215 representing a generic service in an embodiment is shown in greater detail. Particularly, the icon 215 includes a name box 305 that is labeled with a name of the service (“MyService” in the example at issue). A brief description of the service may be displayed in a strip 310, which is opened close to the name box 305 when the user moves a pointer of the mouse (not shown in the figure) over it.

The input parameters of the service 215 are represented with sockets projecting from the name box 305. Particularly, the input parameters may be prompting parameters that are represented with corresponding prompting sockets 315p (ending with cup-like terminals). Each prompting parameter 315p is associated with corresponding prompting code of the service 215, which is adapted to prompt the user to enter the prompting parameter 315p; for example, the prompting code displays an input box 320, and then reads the prompting parameter that the user has typed or selected in it. In this way, the user may provide specific input parameters to the service 215 in a very simple manner. This characteristic may be used when the service 215 invokes a particular functionality of another service that is far more complex; in this case, the service 215 requires the user to enter only the input parameters that are strictly necessary, so as to completely mask the complexity of a user interface of the underlying service.

In addition or in alternative, the input parameters may be extracting parameters that are represented with corresponding extracting sockets 315e (ending with funnel-like terminals). Each extracting parameter 315e is associated with corresponding extracting code of the service 215, which is adapted to extract the extracting parameter 315e from an external service. More specifically, the extracting code invokes the external service; this causes the display of a (home) web page 325 thereof; the user then surfs through the other web pages of the external service (not shown in the figure) by clicking on available hyperlinks and/or entering selection information that may be required. In this way, the user retrieves any desired resulting information (for example, relating to different values of the selection information). Once the choice of the result information has been finalized, the extracting code extracts the extracting parameter from one or more accessible elements of one or more web pages of the external service (with only one accessible element 330 in the web page 325 that is shown in the figure). The accessible element 330 is any artifact (for example, an output box), which may be extracted individually from the web page 325 (i.e., it is associated with a corresponding HTML tag).

In this way, it may be possible to exploit external services already available to provide specific input parameters to the service 215. This characteristic may be used when the service 215 requires input parameters whose selection involves a deep investigation work. For example, the web site of an external service providing tourist information may be used to find information about locations of interest (by surfing through corresponding web pages providing descriptions and images thereof). Once the choice of the web page for a specific location has been finalized, a name of this location is extracted automatically from the web page (for example, from its title bar). Moreover, this allows providing the input parameters to the service 215 directly (without any need for the user that has retrieved the resulting information from the external service to enter it manually). The extracting code may provide the extracting parameter as-is or it may perform any kind of additional processing; for example, when the user selects a city the extracting code automatically retrieves additional information about the city (such as its zip-code) from other external services (with an operation that may be completely transparent to the user).

In an embodiment, a role may be associated with each input (i.e., prompting and/or extracting) parameter. For example, it may be possible to add a role box 335 to the input socket 315p,315e of a specific input parameter. The role box 335 is used to specify a role of the users that are intended to provide the input parameter 315p,315e; the role 335 may be defined statically (by one or more identifiers of its users) or dynamically (by one or more properties of its users). This allows defining collaborative workflows, wherein different users cooperate in the execution of the corresponding aggregated services. For example, an end-user that needs to book a hotel selects one or more searching criteria thereof; the owners of the hotels matching the searching criteria confirm or deny their availability, and the end-user then selects one of the available hotels.

The output parameters of the service 215 are instead represented with corresponding plugs 340 likewise projecting from the name box 305, which output plugs 340 now end with circular terminals.

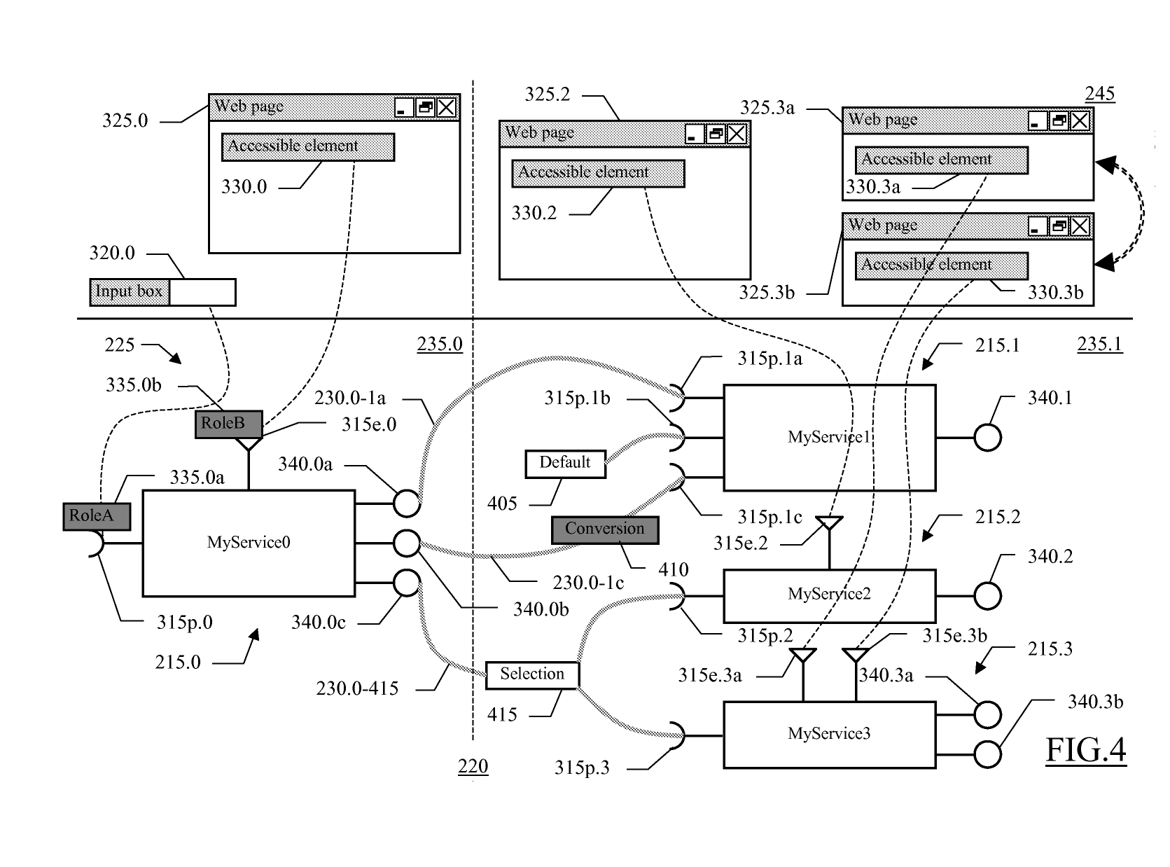

An example of a portion of the graph 225 representing a generic aggregated service in an embodiment of the invention is illustrated in FIG. 4 in the wiring pane 220 (together with the corresponding preview in the presentation pane 245).

More specifically, the first phase 235.0 of the graph 225 includes an (initial) service 215.0 (“MyService0”). The service 215.0 requires a prompting parameter 315p.0 and an extracting parameter 315e.0, and it provides three output parameters 340.0a, 340.0b and 340.0c. The following phase 235.1 of the graph 225 instead includes three (following) services 215.1, 215.2 and 215.3 (“MyService1”, “MyService2” and “MyService3”, respectively). The service 215.1 requires three prompting parameters 315p.1a, 315p.1b and 315p.1c, and it provides an output parameter 340.1. The service 215.2 requires a prompting parameter 315p.2 and an extracting parameter 315e.2, and it provides an output parameter 340.2. The service 215.3 requires a prompting parameter 315p.3 and two extracting parameters 315e.3a and 315e.3b, and it provides two output parameters 340.3a and 340.3b.

In the first phase 235.0, the prompting socket 315p.0 and the extracting socket 315e.0 of the icon 215.0 are left free (i.e., they are associated with no output plug of any preceding service). Therefore, the synchronization code of the aggregated service invokes the prompting code of the prompting parameter 315p.0 so as to cause its prompting through a corresponding input box 320.0; likewise, the synchronization code of the aggregated service invokes the extracting code of the extracting parameter 315e.0 so as to cause its extraction from a corresponding accessible element 330.0 of a web page 325.0. However, a role box 335.0a (for a role “RoleA”) is associated with the prompting socket 315p.0, and a role box 335.0b (for a role “RoleB”) is associated with the extracting socket 315e.0. As a result, the synchronization code of the aggregated service further determines the users belonging to the roles RoleA and RoleB, and then has them provide the corresponding prompting parameter 315p.0 and extracting parameter 315e.0, respectively. In this way, it may be possible to define specific workflows for different roles of the users.

A (simple) connector 230.0-1a links the output plug 340.0a (of the icon 215.0) to the input socket 315p.1a (of the icon 215.1). As a result, the synchronization code of the aggregated service sets the input parameter 315p.1a equal to the output parameter 340.0a. This allows associating input and output parameters in a straightforward way.

The prompting socket 315p.1b (of the same icon 215.1) is instead linked to a default box 405. The default box 405 is used to specify a default value for the corresponding prompting parameter 315p.1b. Therefore, the synchronization code of the aggregated service directly sets the prompting parameter 315p.1b equal to the default value 405. In this way, it may be possible to add services to the graph 225 even if they have input parameters that cannot be associated with the output parameters of the preceding services.

Another simple connector 230.0-1c links the output plug 340.0b (of the icon 215.0) to the input socket 315p.1c (again of the icon 215.1). However, in this case a conversion box 410 is added to the connector 230.0-1c. The conversion box 410 is used to specify a conversion function to be applied to the output parameter 340.0b; the conversion function 410 may be selected among predefined standard functions; examples of operations typically performed by the conversion function 410 is the conversion of a number into a string or vice-versa, the conversion of a date into a number, the extraction of one or more attributes from a complex variable, and the like. The synchronization code of the aggregated service evaluates the conversion function 410, and then sets the input parameter 315p.1c equal to the result of the evaluation. This additional feature may add further flexibility to an embodiment; indeed, the conversion functions may now allow associating services even if their input/output parameters are of different type. As a further improvement, the conversion function may consist of a corresponding service that performs the desired operation. In this way, it may be possible to implement very complex conversions of the input/output parameters (with the same services that are available to solve similar problems in other situations).

It is noted that the icon 215.0 has no input socket that is left free. Therefore, the corresponding service 215.1 is executed in the background without requiring any interaction with the user (so that its execution may be completely transparent to him/her).

A (complex) connector 230.0-415 instead links the output plug 340.0c (of the icon 215.0) to a selection box 415; the selection box is in turn linked to the prompting socket 315p.2 (of the icon 215.2) and to the prompting socket 315p.3 (of the icon 215.3). The selection box 415 is used to specify a selection function to be applied to the output parameter 340.0c of the preceding service 215.0, which selection function provides one of its prompting parameters 315p.2 or 315p.3 of the following services 215.2 or 215.3, respectively. The selection function 415 may be chosen among predefined functions based on standard logic operators (such as equal to, greater or lower than, and the like); moreover, the selection function 415 may be based either on the entire output parameter 340.0c or on some of its attributes (when the output parameter 340.0c consists of a complex variable). In any case, the selection function 415 may be applied to the received values as-is or it may perform any kind of additional processing. The synchronization code of the aggregated service evaluates the selection function 415, and then invokes the following service 215.2 or the following service 215.3 depending on the result of the evaluation—at the same time, setting the corresponding input parameter 315p.2 or 315p.3, respectively, according to the output parameter 340.0c. This allows conditioning the execution of the services dynamically (as a function of whatever condition that is detected at run-time); in this way, it may be possible to define alternative workflows in a single aggregated service.

The extracting socket 315e.2 of the icon 215.2 is instead left free. Therefore, the synchronization code of the aggregated service invokes the extracting code of the extracting parameter 315e.2 so as to cause its extraction from a corresponding accessible element 330.2 of a web page 325.2. Likewise, the extracting sockets 315e.3a and 315e.3b of the icon 215.3 are left free. Therefore, the synchronization code of the aggregated service invokes the extracting code of the extracting parameter 315e.3a so as to cause its extraction from a corresponding accessible element 330.3a of a web page 325.3a, and at the same time it invokes the extracting code of the extracting parameter 315e.3b so as to cause its extraction from a corresponding accessible element 330.3b of a web page 325.3b. The web pages 325.3a and 325.3b may also be associated in a mash-up (as shown by a broken arrow in the figure); therefore, any change in the web page 325.3a is automatically reflected into the other web page 325.3b, and vice-versa.

For example, a preceding service used to select a destination of a holiday provides a corresponding output parameter. The selection function calculates a distance of the destination from a known address of the user (by means of a dedicated service that is invoked in background). If the distance is lower than a predefined threshold it is assumed that the user will reach the destination by car; therefore, a following service providing roadmap information is invoked. Conversely, it is assumed that the user will reach the destination by plane; therefore, a following service of an airline company and a following service of a car renting company are invoked (to book a flight and a car, respectively—with information about the arrival and the departure that are automatically synchronized in the corresponding web pages).

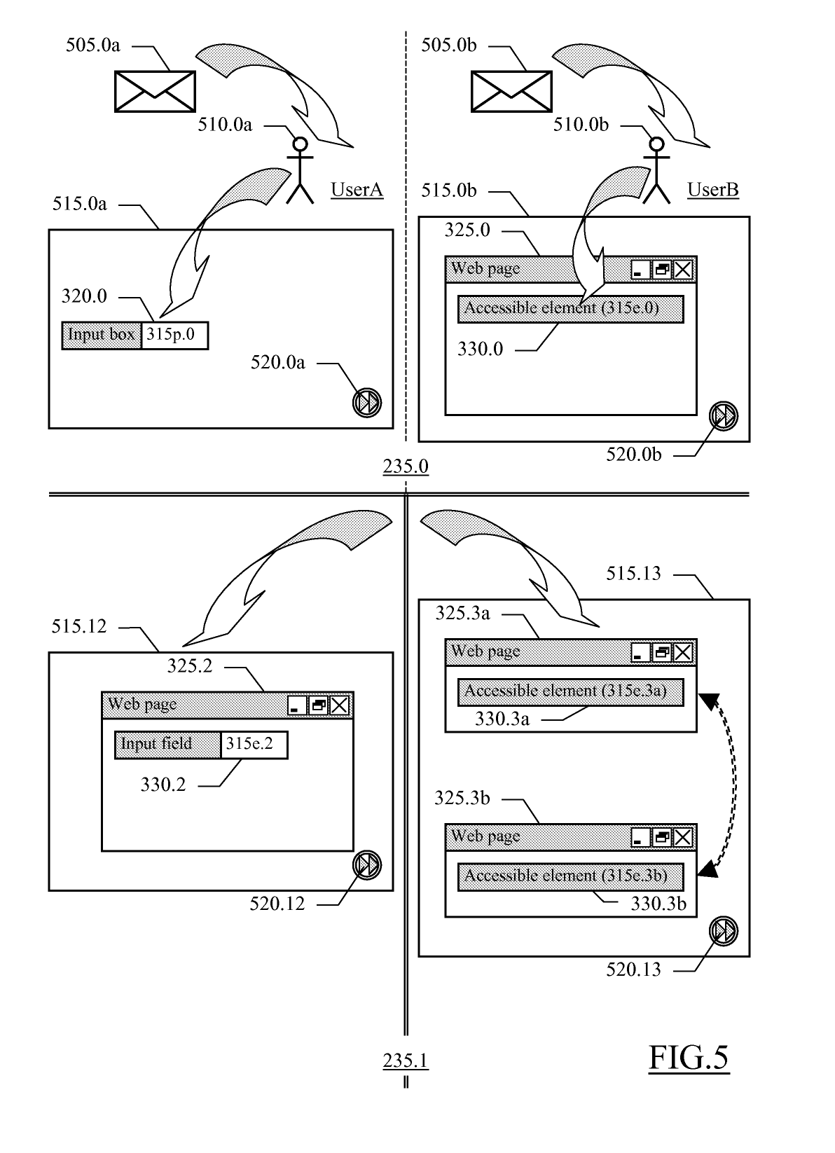

An exemplary scenario of an embodiment is shown in FIG. 5. Particularly, the figure depicts the interaction of the users with the aggregated service that is generated from the above-described graph.

More specifically, during the first phase 235.0 a message 505.0a is sent to each user 510.0a belonging to the role “RoleA” (determined either statically or dynamically); for example, the message 505.0a consists of an e-mail, which asks the user 510.0a to access the aggregated service because an action on his/her part is required. Therefore, when the user 510.0a launches the aggregated service, a corresponding window 515.0a is opened. The window 515.0a includes the input box 320.0 (for providing the prompting parameter 315p.0) and a confirmation command 520.0a (for example, in the form of a button with a double arrow). The user 510.0a enters the prompting parameter 315p.0 into the input box 320.0, and then confirms the operation by clicking with the mouse on the confirmation command 520.0a, in response thereto, the prompting parameter 315p.0 is assigned the current content of the input box 320.0 (with an error message that is displayed if the user 510.0a tries to continue before entering any valid value into the input box 320.0). In a completely independent way, a similar message 505.0b is sent to each user 510.0b belonging to the role “RoleB”. Therefore, when the user 510.0b launches the aggregated service, a corresponding window 515.0b is opened. The window 515.0b now includes the web page 325.0 with the accessible element 330.0 (for providing the extracting parameter 315e.0) and another confirmation command 520.0b. The user 510.0b surfs through the web pages of the corresponding external service—not shown in the figure—for the required result information, and then confirms the choice by clicking with the mouse on the confirmation command 520.0b; in response thereto, the extracting parameter 315e.0 is assigned the current content of the accessible element 330.0. In this case as well, if the user 510.0b tries to continue before the result information has been obtained (i.e., the accessible element 330.0 is not null) a corresponding error message is displayed.

As soon as both the prompting parameter 315p.0 and the extracting parameter 315e.0 have been made available (by the user “UserA” and by the user “UserB”, respectively), the corresponding service 215.0 may process the received information, so as to provide the waited for output parameters 340.0a, 340.0b and 340.0c. This triggers the passage to the following phase 235.1 (for a generic user accessing the aggregated service). In the example at issue, the service 215.1 is invoked in the background. At the same time, the selection function 415 is evaluated (according to the output parameter 340.0c). If the selection function 415 determines that the service 215.2 has to be invoked, the workflow continues to the left. In this case, a window 515.12 is opened; the window 515.12 includes the web page 325.2 with the accessible element 330.2 (for providing the extracting parameter 315e.2) and a confirmation command 520.12. Conversely, if the selection function 415 determines that the service 215.3 has to be invoked, the workflow continues to the right. In this case, a window 515.13 is opened; the window 515.13 now includes the web page 325.3a with the accessible element 330.3a (for providing the extracting parameter 315e.3a) and the web page 325.3b with the accessible element 330.3b (for providing the extracting parameter 315e.3b), which web pages 325.3a and 325.3b are associated in a mash-up application; as above, the window 515.13 also includes a confirmation command 520.13. The process then continues (in the corresponding workflow) as soon as the required input parameters (315e.2 or 315e.3a,315.e3b) have been made available and the confirmation command (520.12 or 520.13) has been selected.

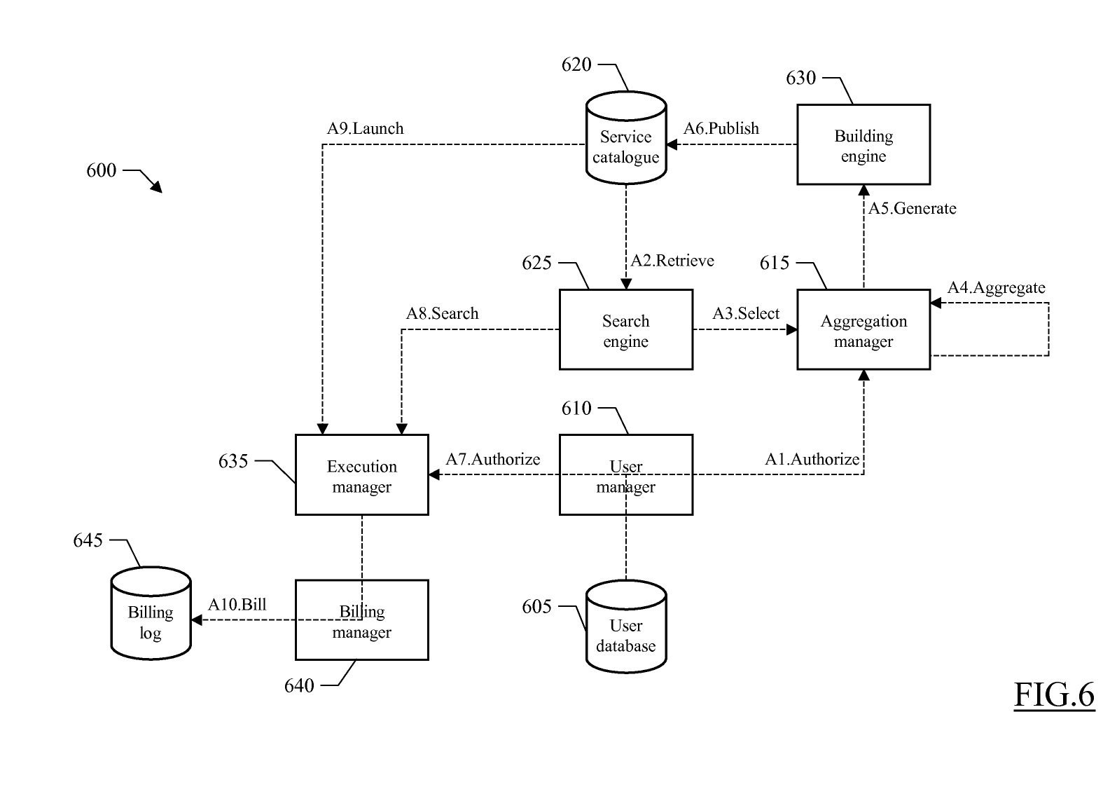

The main software components that may be used to implement an embodiment on a generic server are denoted as a whole in FIG. 6 with the reference 600. Particularly, the figure describes the static structure of the system (by means of the corresponding components) and its dynamic behavior (by means of a series of exchanged messages, each one representing a corresponding action, denoted with sequence numbers preceded by the symbol “A”).

More specifically, a user database 605 stores information about each user that is registered with the server (for example, his/her UserID and password, and a profile with personal data, billing details, authorizations, working groups, and the like). A user manager 610 controls the user database 605 (for updating its content and for retrieving information about specific users). An aggregation manager 615 implements the above-described aggregation wizard. For this purpose, the aggregation manager 615 interfaces with the user manager 610 to authenticate and authorize a current user of the aggregation wizard (action “A1.Authorize”).

A service catalogue 620 stores information about the available services (for example, their name, brief and detailed description, input and output parameters with corresponding attributes, access policy, rate, and the like). The service catalogue 620 also includes a link to a specification of each service; for example, the service may be implemented with an executable program, a script, or a wrapper for one or more pre-existing services. The services in the catalogue 620 are either basic services (implementing a single operation or at most a situational scenario based on a mash-up application) or aggregated services (obtained as described above by assembling multiple basic and/or aggregated services, even recursively). A search engine 625 is used to retrieve and display the services (from the catalogue 620) that meet specific searching criteria—for example, by exploiting tagging, semantic, ontological, or advertising techniques (action “A2.Retrieve”). The aggregation manager 615 interfaces with the search engine 625 to select the services of interest and to retrieve information about them (action “A3.Select”).

The aggregation manager 615 is used to arrange the selected services into corresponding graphs—either new or derived from pre-existing ones (action “A4.Aggregate”). Once a specific graph has been completed, the aggregation manager 615 controls a building engine 630 to generate glue code (i.e., the access point, the starting code and the synchronization code) for the corresponding aggregated service (action “A5.Generate”). The building engine 630 then publishes the aggregated service so obtained into the service catalogue 620 (action “A7.Publish”).

An execution manager 635 is in charge of serving the requests of execution of the services that are submitted by the users. For this purpose, the execution manager 635 interfaces with the user manager 610 to authenticate and authorize each user (action “A7.Authorize”). The execution manager 635 then exploits the search engine 625 to find the desired services, which the user is authorized to execute among the ones available in the service catalogue 620 (action “A8.Search”). The execution manager 635 retrieves the link to each service to be submitted for execution from the service catalogue 620, and then launches it (action “A9.Launch”). A billing manager 640 receives usage information about the services that are executed by each user from the execution manager 635 (for example, its execution time and rate). The billing manager 640 updates corresponding billing information of the user into a billing log 645 accordingly (action “A10.Bill”).

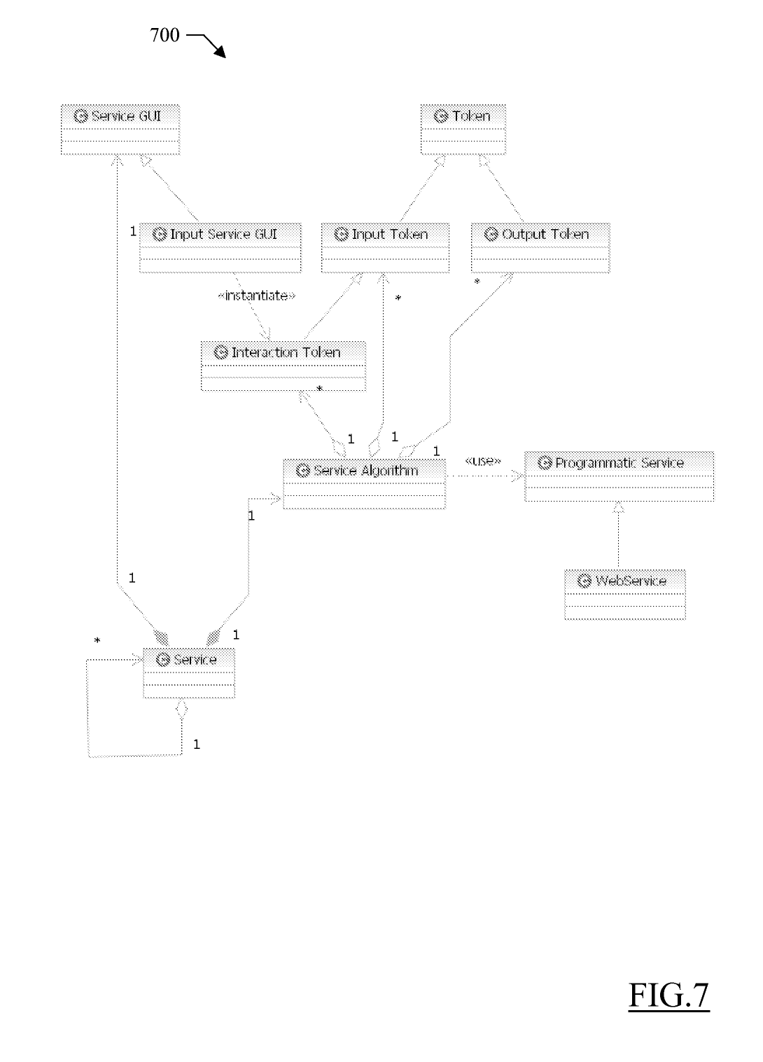

Moving now to FIG. 7, there is illustrated a class diagram 700 that models an example of service in an embodiment of the invention. Particularly, the figure provides a static representation of the service by means of its classes and their interactions; each class represents an entity of the service that encapsulates certain functionality (with specific attributes defining its properties, and methods exposing functions available to other classes).

More specifically, the service is defined by a corresponding class “Service”. The class “Service” is a package formed by any number of the same class “Service”—as indicated by a corresponding weak aggregation, represented by an arrow starting with an unfilled diamond (meaning that each class “Service” may belong to other classes as well). The class “Service” includes a class “Service GUI” (defining the corresponding GUI) and a class “Service Algorithm” (defining its functionality), as indicated by corresponding strong aggregations, represented by arrows starting with filled diamonds, meaning that the (source) class “Service” has the (target) classes “Service GUI” and “Service Algorithm” (with the target classes that may belong to the source class only).

The class “Service Algorithm” uses a class “Programmatic Service” (i.e., it invokes its methods)—as indicated by a corresponding dependency, represented with a dashed-line arrow. The class “Programmatic Service” provides the code implementing the service. For example, the service may be based on the web service technology; in this case, a class “WebService” extends the class “Programmatic Service”—as indicated by a corresponding relationship, represented with an arrow with a triangular tip, meaning that the (source) class “WebService” inheritances the functionality of the parent (target) class “Programmatic Service”.

The class “Service Algorithm” includes any number of classes “Interaction Token” (for its extracting parameters). The class “Interaction Token” instantiates the class “Input Service GUI” (for extracting the desired values from the web pages of the relevant external service)—as indicated by a corresponding dependency, represented with a dashed-line arrow; the class “Input Service GUI” in turn extends the class “Service GUI”. The class “Service Algorithm” also includes any number of classes “Input Token” (for its prompting parameters)—with this class “Input Token” that is extended by the class “Interaction Token”. At the end, the class “Service Algorithm” includes any number of classes “Output Token” (for its output parameters). Both the classes “Input Token” and “Output Token” extend a (parent) class “Parameter” (for any kind of input/output parameters of the service).

Naturally, in order to satisfy local and specific requirements, a person skilled in the art may apply to the embodiment(s) described above many logical and/or physical modifications and alterations. More specifically, although reference has been made to one or more embodiments, it should be understood that various omissions, substitutions and changes in the form and details as well as other embodiments are possible. Particularly, an embodiment may even be practiced without the specific details (such as the numerical examples) set forth in the preceding description to provide a more thorough understanding thereof; conversely, well-known features may have been omitted or simplified in order not to obscure the description with unnecessary particulars. Moreover, it is expressly intended that specific elements and/or method steps described in connection with any disclosed embodiment of the invention may be incorporated in any other embodiment as a matter of general design choice.

Particularly, an embodiment lends itself to be implemented with an equivalent method (by using similar steps, removing some steps being non-essential, or adding further optional steps); moreover, the steps may be performed in a different order, concurrently or in an interleaved way (at least in part).

Similar considerations apply if the aggregation wizard includes different and/or additional functions, or it is replaced with any equivalent user interface. Moreover, further tools may be provided to facilitate the management of the services (such as blogs, wiki sites, rating facilities, and the like); vice-versa, some of the above-described characteristics may be omitted in a simplified implementation (such as the billing manager when the services are all free of charge).

It should be readily apparent that the above-mentioned scenarios are merely illustrative and in no way limitative; more generally, an embodiment may be applied to automate any kind of activities in the broadest meaning of the term. Likewise, the services that are aggregated may be of whatever type (for example, conforming to the SOA standard).

Alternatively, the extracting parameters may be obtained from other output elements of the web pages (for example, a title of a frame, a content of a banner, an image or a video of a player window, and the like).

Moreover, nothing prevents exploiting input fields of the web pages for the same purpose. More generally, the extracting parameters may be obtained from any accessible elements of the web pages—even if they are not visible.

The possibility of having only prompting parameters or only extracting parameters is not excluded. Moreover, it may also be possible to provide predefined input parameters intended to be entered always at run-time through interaction with the uses and other predefined input parameters instead intended to be associated always with output parameters of preceding services.

Alternatively, the roles of the user may be defined in any other way (for example, only statically or only dynamically); moreover, the notifications may be sent to the relevant users through other channels (for example, instant messages).

Any other functions may be added to facilitate the execution of the aggregated services (for example, forward commands, skip commands, and so on).

More generally, the connectors (or any equivalent elements) may associate any number of preceding output parameters of one or more preceding services with any number of input (i.e., prompting and/or extracting) parameters of one or more following services.

As a further improvement, the aggregation wizard may suggest how to arrange the simple connectors (according to the type of the available input and output parameters).

Moreover, the default values may be pre-defined in the services, so as to be associated automatically with selected input parameters whose sockets are left free.

The above-mentioned conversion functions are merely illustrative, and they are not to be interpreted in a limitative manner.

Similar considerations apply to the services that may be used to implement them.

The complex connectors may be based on any number of output parameters of one or more preceding services; moreover, they may select any number of input parameters of two or more following services; however, the same technique may also be used to select alternative input parameters of the same following service (with each other unselected input parameter thereof that is instead unused or set to a default value).

In any case, it should be noted that an embodiment lends itself to be implemented with only some (or even none) of the above-described additional features—for example, only supporting simple connectors, without the possibility of differentiating the workflows for the roles of the users, and so on.

Similar considerations apply if the program (which may be used to implement an embodiment) is structured in a different way, or if additional modules or functions are provided; likewise, the memory structures may be of other types, or may be replaced with equivalent entities (not necessarily consisting of physical storage media). In any case, the program may take any form suitable to be used by any data processing system or in connection therewith (for example, within a virtual machine); particularly, the program may be in the form of external or resident software, firmware, or microcode (either in object code or in source code—for example, to be compiled or interpreted). Moreover, it is possible to provide the program on any computer-usable medium; the medium may be any element suitable to contain, store, communicate, propagate, or transfer the program. For example, the medium may be of the electronic, magnetic, optical, electromagnetic, infrared, or semiconductor type; examples of such medium are fixed disks (where the program can be pre-loaded), removable disks, tapes, cards, wires, fibers, wireless connections, networks, broadcast waves, and the like. In any case, an embodiment lends itself to be implemented even with a hardware structure (for example, integrated in a chip of semiconductor material), or with a combination of software and hardware.

Moreover, the proposed service may be offered by any equivalent service provider, such as consisting of a cluster of servers. In any case, an embodiment also lends itself to be implemented with modules that are resident on the clients.

An embodiment may also be carried out on a system having a different architecture or including equivalent units (for example, based on a local network). Moreover, each computer may have another structure or may include similar elements (such as cache memories temporarily storing the programs or parts thereof); in any case, it may be possible to replace the computer with any code execution entity (such as a PDA, a mobile phone, and the like), or with a combination of multiple entities (such as a multi-tier architecture, a grid computing infrastructure, and the like).

From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated.

1. A method for assembling services available in a data processing system with distributed architecture, each service requiring a set of input parameters and/or providing a set of output parameters, wherein the method includes the steps of:
displaying a representation of each service in a graphical user interface,
selecting a plurality of representations of the services in the graphical user interface,
arranging the selected representations of the selected services into a graph in the graphical user interface, the graph including a set of connectors each one associating a set of preceding selected representations of preceding selected services to a set of following selected representations of following selected services, and
generating an aggregated service from the graph, the aggregated service including an access point to the aggregated service, starting code for invoking each initial selected service associated with no preceding selected service in response to an invocation of the aggregated service through the access point, and synchronization code for setting the input parameters of each set of following selected services according to the output parameters of the associated preceding selected services and for invoking each set of following selected services in response to an availability of the output parameters of the associated preceding selected services.

2. The method according to claim 1, wherein at least one input parameter of at least one service is an extracting parameter associated with extracting code for extracting the extracting parameter from at least one page of an external service, and wherein the step of generating an aggregated service includes:
adding synchronization code for invoking the extracting code of each extracting parameter associated with no output parameter.

3. The method according to claim 2, wherein the extracting code is adapted to extract the extracting parameter from at least one accessible element of the at least one page.

4. The method according to claim 3, wherein each accessible element is an output element being displayed in the corresponding page.

5. The method according to claim 1, wherein at least one input parameter of at least one service is a prompting parameter associated with prompting code for prompting an entering of the prompting parameter, and wherein the step of generating an aggregated service includes:
adding synchronization code for invoking the prompting code of each prompting parameter associated with no output parameter.

6. The method according to claim 1, wherein the step of arranging the selected representations includes:
associating at least one input parameter of at least one following selected service associated with no output parameter with an indication of a set of users,
and wherein the step of generating an aggregated service includes:
adding synchronization code for causing the users associated with each input parameter to provide the associated input parameter.

7. The method according to claim 1, wherein the step of generating an aggregated service includes:
adding synchronization code for displaying a confirmation command for each set of preceding services, the invocation of the associated following services being conditioned to the confirmation command.

8. The method according to claim 1, wherein the step of arranging the selected representations includes:
associating at least one input parameter of at least one following selected service with a single output parameter of the associated preceding selected services,
and wherein the step of generating an aggregated service includes:
adding synchronization code for setting each input parameter associated with a single output parameter to the associated output parameter.

9. The method according to claim 1, wherein the step of arranging the selected representations includes:
associating at least one input parameter of at least one following selected service with a default value,
and wherein the step of generating an aggregated service includes:
adding synchronization code for setting each input parameter associated with a default value to the associated default value.

10. The method according to claim 1, wherein the step of arranging the selected representations includes:
associating at least one input parameter of at least one following selected service with a conversion function based on a set of output parameters of the associated preceding selected services,
and wherein the step of generating an aggregated service includes:
adding synchronization code for evaluating each conversion function and for setting the associated input parameter to the evaluation of the conversion function.

11. The method according to claim 10, wherein the step of associating at least one input parameter of at least one following selected service with a conversion function includes:
associating the at least one input parameter of the at least one following selected service with a conversion service implementing the conversion function,
and wherein the step of adding synchronization code for evaluating each conversion function includes:
adding synchronization code for invoking the corresponding conversion service.

12. The method according to claim 1, wherein the step of arranging the selected representations includes:
associating at least one plurality of groups of input parameters of corresponding groups of following selected services with a selection function based on a group of output parameters of the associated preceding selected services,
and wherein the step of generating an aggregated service includes:
adding synchronization code for evaluating each selection function and for selecting one of the associated groups of following selected services for the invocation according to the evaluation of the selection function.

13. The method according to claim 1, further including the step of:
publishing the aggregated service.

14. The method according to claim 1, further including the step of:
executing the aggregated service in response to a call of the access point.

15. A computer program including code means for causing a data processing system to perform the steps of the method according to claim 1 when the computer program is executed on the system.

16. A service including code means for causing a service provider of a data processing system to perform the steps of the method according to claim 1 when the service is executed on the service provider.

17. A system including means for performing the steps of the method according to claim 1.

18. A server for use in the system according to claim 17, the server including means for offering a service implementing the method according to claim 1.
